(19) United States
(12) Patent Application Publication
(10) Pub. No.: US 2009/0307129 A1
(43) Pub. Date: Dec. 10, 2009

(54) COMMUNITY-BASED WORK VALUE SYSTEM AND METHOD

(76) Inventors: Jonathan Matkowsky, Palo Alto, CA (US); Athellina Athsani, San Jose, CA (US); Christopher Kalaboukis, Los Gatos, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/134,430

(22) Filed: Jun. 6, 2008

(51) Int. Cl. G06Q 10/00; G06Q 20/00; G06Q 99/00

(52) U.S. Cl. 705/39; 705/1

(57) ABSTRACT

Disclosed herein are a system and method to identify one or more tasks, determine a community corresponding to an identified task, receive input from the determined community, e.g. valuation input, suggestions on a performer of the task, inquiry input, etc. A value is assigned for the task using input received from the determined community. The determined community that values the task may be responsible for paying an amount equal to the value of the task identified by the community in exchange for performance of the task.

### FIELD OF THE DISCLOSURE

The present disclosure relates to identifying and valuing tasks, and more particularly to a system and method to identify and value one or more tasks to be performed in connection with a community.

### BACKGROUND

A task that is to be performed for money requires that the task be valued and funded. For example, road construction typically falls under the purview of a governmental agency, e.g., a city, state or federal agency, that takes the responsibility to identify the work that is to be performed, budget an amount to perform the work, oversee the work, and appropriate the funds needed for the work. However, there are a number of tasks that are never performed because no one takes the responsibility for the task.

### SUMMARY

The present disclosure seeks to address failings in the art and to provide a system and method for identifying tasks and valuing the identified tasks. In accordance with one or more embodiments disclosed, information associated with a task is received from a user and stored, a community of users is identified to value the task and a request is forwarded to each user in the identified community so that the users can identify a value for the task, one or more responses are received from the community of users, and a value for the task is determined using the one or more received responses.

In accordance with one or more embodiments, a community of users that value a task are responsible for appropriation of the funds corresponding to the identified value of the task. In accordance with at least one embodiment the value determined from the responses received from the community of users is provided to the community of users for approval. The community of users is identified, in accordance with at least one embodiment, from a user base that can comprise individuals, or other entities that are represented by one or more individuals, the user community comprising users, e.g., individuals or other entities, for which a relevance to the task has been identified. In at least one embodiment, the one or more responses received are analyzed to determine a value, e.g., a single value, or a value range comprising a minimum and a maximum, from which a value for the task is identified. In accordance with one or more embodiments, the value identified from the value range is an average value. In accordance with one or more embodiments, a weighting is given to each value in the one or more responses from the community of users selected to value the task. Factors that can be used to determine weighting for a given user can comprise, without limitation, a prediction of accuracy, which can be based on the user's response to one or more previous valuation requests, a known level of expertise of the user, a degree to which a user is to contribute to funding the task, etc.

In accordance with one or more embodiments, a task can comprise multiple subtasks, each of which can be treated as a task.

By virtue of this arrangement, for example, a mechanism is provided to identify one or more tasks, and for each task identified a community of users can be determined to value the task. Responsibility for funding the task can be determined as well, and can be assigned to the community that values the task. Alternatively, funding for the task can be obtained from sources other than the community of users, which sources can include a philanthropic third party, charitable, or other, donor, a task's performer(s), users that are not members of the community that valued a task, etc.

By way of a non-limiting example, a charitable party, e.g., a user, non-user or other entity, can donate an item of value to a second party in exchange for a commitment by the second party to perform a task, e.g., a task that has an assigned value based on input received from a community of users. The assigned value of a task can be used as evidence of the amount of the charitable donation. In the example, the amount of the charitable donation, e.g., the value of the item donated, can correspond to the assigned value of the task. Other non-limiting examples of donations include other non-cash donations, e.g., donation of time spent in the performance of a task, monetary donations, e.g., a monetary donation used to fund a task, etc. One or more embodiments of the present disclosure can provide information that can be used for tax purposes, and can provide an incentive for users to make a donation, e.g., to offer their time, in the connection with one or more tasks valued in accordance with one or more embodiments. In so doing, embodiments of the present disclosure can promote charitable acts. In accordance with one or more such embodiments, a statement can be generated to provide confirmation of the amount of the donation. If the donation is in the form of a monetary donation, the statement can identify the amount of money donated, for example. The statement can provide evidence of a noncash charitable donation. By way of a non-limiting example, the statement can provide confirmation of the amount of time spent on the task, together with evidence of the value of the time spent on the task, for example. If, as is discussed above, the donation comprises an item that is donated, the statement can provide evidence of the value of the task performed in return for the item being donated.

In accordance with at least one embodiment, input is received that identifies a task that is to be performed. A community of users is selected for the identified task from a user base, and the determined community of users is requested to value the identified task. A value is assigned for the task using valuation input received from the determined community of users. In accordance with one such embodiment, a system is provided that comprises one or more computing devices configured to provide the functionality. In accordance with another embodiment, the functionality is embodied in steps of a method performed by at least one computing device. In accordance with another embodiment, program code to implement the functionality is tangibly embodied on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides an example of a task identification and valuation process flow in accordance with one or more embodiments of the present disclosure.

FIG. 2 provides an example of a task entry user interface element for use in accordance with one or more embodiments of the present disclosure.

FIG. 3 provides an example of a task detail and summary user interface element for use in accordance with one or more embodiments of the present disclosure.

FIG. 4 provides an example of an expertise rating user interface element for use in accordance with one or more embodiments of the present disclosure.

FIG. 5, which comprises FIGS. 5A and 5B, provides an example of a task value determination process flow in accordance with one or more embodiments of the present disclosure.

FIG. 6 provides an example of a task value entry user interface element for use by the community members to provide task input in accordance with one or more embodiments of the present disclosure.

FIG. 7 provides a component overview illustrating components which can be used in connection with one or more embodiments of the present disclosure.

### DETAILED DESCRIPTION

In general, the present disclosure includes a task identification and valuation system, method and architecture.

Certain embodiments of the present disclosure will now be discussed with reference to the aforementioned figures, wherein like reference numerals refer to like components.

In accordance with one or more embodiments, a system, which comprises one or more computing devices executing program code, is configured to provide a system and method to identify one or more tasks, determine a community corresponding to an identified task, receive input from the determined community, e.g., value, performer, inquiry input, assign a value to a task using input received from the determined community. In accordance with one or more such embodiments, the determined community values the task and is responsible for paying an amount equal to the value of the task identified by the community in exchange for the performance of the task.

The system and method provided in accordance with one or more embodiments of the present disclosure allow a user to enter information to identify a task, use the information associated with the task as well as other information, such as without limitation user profile information, to determine a community of users for an identified task, notify member users of a determined community of an identified task and request task input, including valuation input, from the members, determine a value for the task using task valuation input received from the community's members, authorize performance of the identified task, and perform reconciliation of an amount equal to the value of the task determined using the community's input. In accordance with one or more embodiments, reconciliation comprises charging one or more members of the community for the amount of the task.

In accordance with one or more embodiments of the present disclosure, a computer-readable medium embodies program code to configure one or more computing devices to perform functionality disclosed herein. Such functionality includes, without limitation, functionality provided by a system, method, and/or architecture disclosed herein.

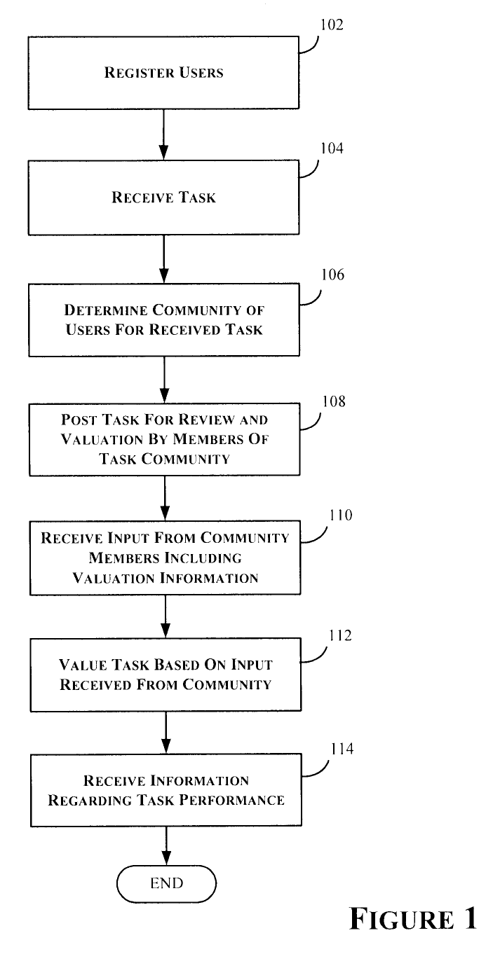

FIG. 1 provides an example of a task identification and valuation process flow in accordance with one or more embodiments of the present disclosure. At step 102, one or more users are registered. In accordance with one or more embodiments, as part of registration, a user provides information such as the user's full name, home address and telephone number, employment information (e.g., employer's address, work telephone number, years of employment, etc.), contact information in addition to the address and telephone number information, such as the user's electronic mail address, instant messaging address, facsimile number, etc., which can be used to communicate with the user, e.g., valuation requests, task approval, billing, etc. In accordance with one or more such embodiments, a user can provide credit card information (e.g., name listed on the card, card number, expiration date, authorization code, etc.), which can be used to collect the user's portion of the value of a task. As is described in more detail below, the information provided by the user during registration can be verified, including the credit card information input by the user.

In accordance with one or more embodiments, a user base can be defined to be persons, or other entities such as corporations, businesses, governmental agencies, etc., that make use of capabilities, e.g., task input and/or valuation, provided in accordance with one or more embodiments of the present disclosure. In accordance with one or more such embodiments, a database, or other data store, stores information about each user. At least a portion of a member's information is collected during a new user registration. Other information can be collected as a user uses the functionality disclosed herein, e.g., task entry, task valuation, task status, valuation/performance critiques, expertise, and the like. In addition to user information and in accordance with one or more embodiments of the present disclosure, information about tasks, including without limitation, task input received from one or more members, task valuation, task performance, etc. can be stored. In accordance with one or more embodiments and as described in more detail below, user registration can be limited, e.g., users must be invited to join or in some manner pre-approved in order to register.

At step 104, input identifying a task is received from a registered user. By way of a non-limiting example, information input by the user can include a task title, description, how performance will be assessed, location, category, as well as suggested community, performer, start and end dates, duration, personnel needs, equipment needs, and/or equipment availability. At step 106, a community of users is determined for the task input at step 104. The determined community can comprise a suggested community identified at the time the task was entered, and/or a community identified by the system based on other information provided for the task.

In accordance with one or more embodiments, the community of users can be determined by filtering the user base using one or more filtering criteria to identify users for a community for purposes of a given task. The criteria can vary from one task to another, and can be based on information associated with the task and/or the information known about the users in the user base. For example, assuming that the task has a spatial component, e.g., the task affects a specific location, e.g., a town square, a park, etc., the criteria used to filter the user base can examine where each user lives, and/or works, in relation, or proximity, to the town square, and/or whether and to what extent a user uses or visits the area, etc.

In accordance with one or more such embodiments in which a spatial filtering component is used, the filtering can take into account a user's address information, e.g., home, work, etc. Alternatively, the spatial component can use information about a user's physical location, e.g., present or past physical location or a prediction of a physical location that can be based on the user's present and/or past physical location. A physical location can be determined using a device, e.g., device enabled with a global positioning system (GPS), which reports the user's current physical location. Alternatively, a user's cellular device can be used to determine a physical location based on cellular tower usage. Other mechanisms for determining a physical location at a given point in time can be used in connection with any one or more embodiments of the present disclosure.

The spatial component can also take into account a user's physical location over time, e.g., physical movements. A user's spatial information can be analyzed in relation to spatial criteria associated with a task to determine whether the user is a part of a task's community. By way of a non-limiting example, spatial information associated with a user can be retrieved and analyzed against geographic, or other spatial, information associated with a task to determine whether or not the user has a spatial “connection” to the task. For example, if a task involves clearing debris from a town square, in accordance with at least one embodiment in which a spatial component is used to filter the user base and determine a community of users, the task's community can comprise business or residential users, located in and/or within a proximal distance of the town square, and/or users who visit, or otherwise use, the town square, e.g., users that are determined to “use” the town square based on an extrapolation that involves examining physical location information collected for, and/or from, the users. Embodiments of the present disclosure can be used to exclude that part of the user base that lives or works at least a threshold distance away from the town square, and/or that visit the town square fewer than a threshold number of times, e.g., users that never or rarely visit the square. The threshold frequency can be used in connection with visitation information over some period of time, e.g., past number of years, months, weeks, days, or hours.

Other examples of criteria that can be used to filter the user base can include, without limitation, temporal, social, and/or topical criteria. To illustrate without limitation, a temporal criteria can be used in a case that the task takes place or affects a specific time, e.g., time of day, day of the week/month/year, week of the month/year, month of the year, etc. or time period, e.g., a time period with a start and end date. By way of a non-limiting example and in a case that a requirement of a task is that the task be performed at a specific time or period of time, a temporal criteria can be used to determine a task's community based on those users that are affected by the task to be performed at the specific time or period of time. To further illustrate and without limitation, an example of a type of task that can have a temporal component includes developing a web site, which is to provide public service information, by a given date. The member community for a task can be determined to be those users that have events scheduled after the date on which the web site is to be activated, which could be posted on the web site.

Social criteria can be used to determine whether or not there is a social connection between a task and one or more users. By way of a non-limiting example, a group of users from the user base that belong to a club that meets at an equestrian center have a connection to a task involving the maintenance of the equestrian center. A social community can include a group of users determined to be socially interconnected in some manner, e.g., by virtue of their enrollment in an organization or social network, and/or by virtue of like identifiers, e.g., a self-identifier, associated with each person in the group. Groups can be determined by a declared affinity (a member of a Classic Car group), or by virtue of an indirect association or declaration (an employee of a given entity). In accordance with one or more embodiments, a social community can include a group of users determined by their social network, whether expressly declared or inferred, the latter of which can be based on one's online interactions or connections, for example. By way of a further non-limiting example, information can be collected based on a user's activities at a site, e.g., social bookmarking site. In accordance with one or more such embodiments, information collected about a user based on the user's online activities can be used in combination with the information collected from the user as part of the user's registration with the system as well as the user's other interaction(s) with the system, e.g., task input, valuation, performance, etc.

Topical criteria can be used in filtering to identify a user community, e.g., the topical criteria can involve a given topic, tag, or item of information that associates one or more users of the user base and the task, for example. In accordance with one or more embodiments, users can be grouped based on a shared interest in a given topic. A “topical community” might include a group of users who are interested in a specific topic even though the users may not expressly declare an interest in the topic, e.g., a user may expressly or implicitly “declare” interest. To illustrate by way of a non-limiting example, a user may be grouped with other users as part of a member community associated with the task of “building a skate park” by virtue of knowledge collected about each user's respective interests. To illustrate using a further non-limiting example, one or more users can be included in the task's community as a result of online searches conducted by each user related to such topics as skating, skate parks, skating equipment, etc. Thus, in accordance with one or more embodiments, a user can be included in the task's community based on a topical affiliation between the user and the task, which affiliation can be inferred from information collected about the user.

The criteria used for a given task can be a combination of one or more criteria, and can include criteria other than that discussed above. In accordance with at least one embodiment disclosed herein, community membership can be determined automatically and without a user requesting to be included in a task's community. Alternatively and in accordance with one or more embodiments, a user can express interest in a given task, and can request to be included in the task's community. In accordance with one or more such embodiments, a user's request to be included in a task's community can be granted with or without review and/or approval. Such review can comprise a review of a user's explanation for requesting inclusion, the user's relationship to the task, etc. As yet another alternative for use in connection with one or more embodiments, community membership can comprise both an automatic component and by request.

At step 108 of FIG. 1, the task is posted for review and appraisal, or valuation, e.g., identification of a value for the task, by the determined members of the task community. At step 110, input is received from the member community including valuation information. In accordance with one or more embodiments, a member of the community can provide a value for the task, e.g., a single value and/or a range of values. Alternatively, a member of the community can request further information regarding the task, e.g. additional details regarding a scope of the task, materials and/or equipment needed for the task, exact location of the task, information regarding the person to perform the task, etc. An inquiry from a member of the community can be forwarded to the user that initiated/entered a task, or another user, or even a non-user, to provide the requested information.

At step 112, a value of the task is determined using the valuation information provided by one or more members of the task community. At step 114, information is received regarding performance of the task.

In accordance with one or more embodiments of the disclosure, a user interface is provided for a user to input valuation, or other information, for a task. In accordance with one or more such embodiments, the user interface comprises interface elements, such as without limitation, a screen, window, panel, web page etc., which can be displayed for a user using a computing device. By way of a non-limiting example, the user interface comprises at least one web page that is displayed for the user in a browser window via the computing device, a definition for the at least one web page can be provided by one or more servers to the user's computing device via a network, e.g., the Internet.

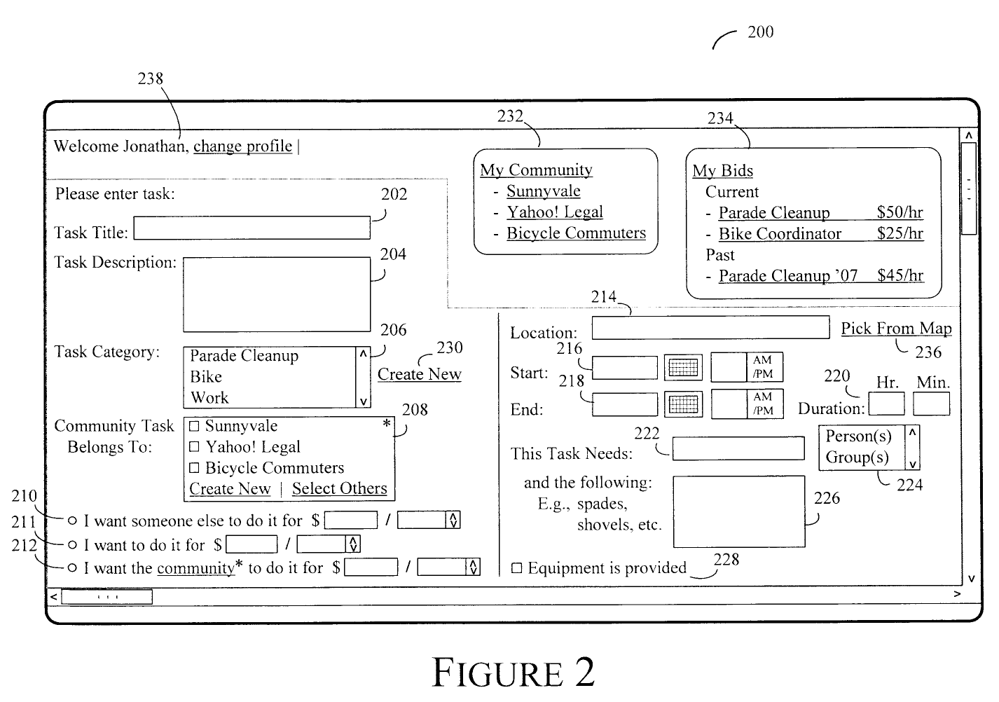

FIG. 2 provides an example of a task entry user interface element for use in accordance with one or more embodiments of the present disclosure. Web page 200 can be provided from a server to a user's computing device in response to a request received from the user to enter a new task. The request for web page 200 can be made by selecting a link to web page 200 from a web page displayed for the user once the user has logged into the system, for example. By entering information into fields of the web page 200, a user can define a new task, and/or edit previously-entered task information. By way of a non-limiting example, the user can specify such information as a title for the task, field 202, a task description, field 204, a task category, field 206, one or more suggested communities for the task, field 208, a suggestion as to whom should perform the task and for how much, selection items 210 to 212, a location, field 214, a start and end of the task, fields 216 and 218, a task duration, field 220, personnel, e.g., a person or group of people, needed for the task, fields 222 and 224, equipment needed for the task, field 226, and/or whether equipment will be provided (e.g., by the persons or groups of people that perform the task), field 228.

Field 206 comprises a list of existing task categories, and can include a scrolling capability to view other existing categories. A new task category can be created by selecting the “Create New” link 230. In accordance with one or more embodiments of the disclosure, one or more task categories specified by the user can be used to identify members of the task's community. By way of a non-limiting example, a task category can be used as a keyword in a search of the information stored for the user base to select users from the user base for the task's community, e.g., the task category “Bike” can be used to identify users in the user base that have stored information indicating an affiliation with a bike user category, belong to a bike club, performed an online search for bike equipment, expressed an interest in biking, e.g., through social bookmarking, users' RSS feeds stored in connection with their user profile, etc.

Field 208 can be used, in accordance with one or more embodiments, to specify an existing community, or grouping, of users that can be used to identify members of the task community. By way of a non-limiting example, selection of the Sunnyvale entry in field 208 can be used to identify users for inclusion in the task community that live and/or work in Sunnyvale, and/or Sunnyvale area, or are in some way affiliated with Sunnyvale or the surrounds. The user can select from the entries displayed in field 208, and/or additional community entries can be displayed using the “Select Others” link. In addition, the user can create a new community, or grouping, of users. In accordance with one or more embodiments, initial set of communities listed in field 208 correspond to the communities to which the user entering the task belongs. Portion 232 of web page 200 comprises links to, and allows the user to edit, as appropriate, the communities to which the user belongs.

Portion 234 of web page 200 allows the user to review bids submitted by the user for both current and past, e.g., completed, tasks. The user's bids can be for tasks entered by the user and/or tasks for which the user has submitted a bid to perform a task that was entered by another user, for example.

Fields 210 to 212 allow the user to indicate whether the user wishes to perform the task, have someone else perform the task, or have a community, e.g., such as the communities displayable in field 208, perform the task. Each of fields 210 to 212 allows the user to specify a monetary amount, e.g. a dollar amount, for the task. The amount specified can be a total amount for the task or by a given time measurement, e.g., per hour, day, week, month, etc. The start and end fields 216 and 218, respectively, can be used to identify start and end dates of the task. The user can use a calendar interface to specify the date. The start and end fields 216 and 218 also allow the user to specify start and end times of the day. Field 220 allows the user to specify a duration of the task, e.g., in terms of hours and minutes. The location of the task can comprise textual input via field 214, or by selecting a location via a map displayed in response to selection of link 236. A greeting 238 identifies the user by name, and link 240 allows the user to view and change, as appropriate, the user's stored information, e.g., user profile information.

In accordance with one or more embodiments, a summary of the task details can be provided to the user. A summary can be provided prior to submission of the task for processing by the system. In accordance with one or more embodiments, a user can elect to save the task without submitting the task for processing and appraisal. A summary of the task's details can be provided to the user so that the user can make modifications before submitting the task to the system for valuation by a community of users determined to value the task.

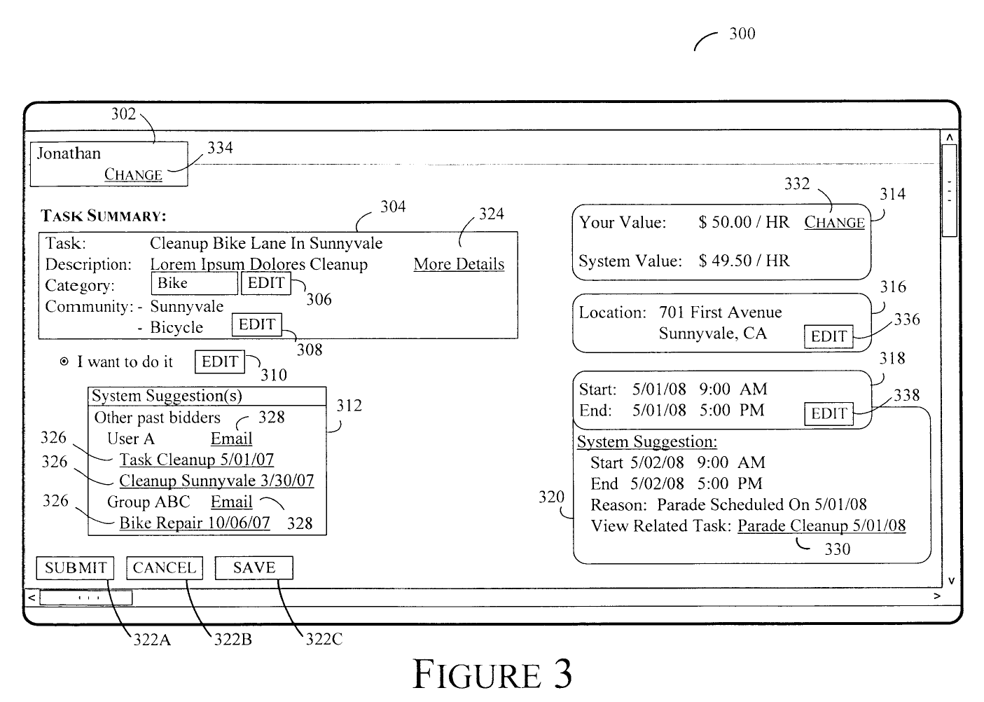

FIG. 3 provides an example of a task detail and summary user interface element for use in accordance with one or more embodiments of the present disclosure. As with each of the user interface elements disclosed, the user interface element shown in FIG. 3 can be a web page delivered to a user's computing device by at least one server in communication with the user's computing device via a network. e.g., the Internet. Web page 300 includes a user identification portion 302, which identifies the user by name and allows a different user to log in, via the “CHANGE” link 334, e.g., a different user wishes to use the system. Portion 304 provides a summary of the information specified for the task, including the task's title, description, category, and community(ies). Portion 304 also allows the user to edit task information, such as the category and community information for the task, via “EDIT” buttons 306 and 308 (respectively), and/or view additional details about the task via link 324. In the example shown in FIG. 3, the task summary indicates that the user elected to perform the task, and allows the user to edit the election via the “EDIT” button 310. For example, the user can identify someone else to perform the task instead of the user.

Portion 312 of page 300 provides suggestions generated by the system that identifies other users and/or groups of users that have provided a bid in the past, might be interested in performing the task, and/or might be a good fit to perform the task. Portion 312 of web page 300 can provide contact information corresponding to the suggestions. For example, as shown in the web page 300, portion 312 includes a link 328 to allow a user to e-mail an entity, e.g., a user or group of users, listed in portion 312. Portion 312 also lists previous tasks associated with each suggestion and a link 326 that allows the user to view details about the previous tasks.

Portion 314 of web page 300 identifies the user's pay rate, e.g., an hourly rate, for the task and a pay rate identified by the system for the task. The user can elect to change the user's pay rate via link 332 of portion 314. Portion 316 of web page 316 displays the location of the task and allows the user to edit the task location. The user can change the location of the task via the “EDIT” button 336. Portion 318 displays the start and end dates and times and allows the user to edit this information via the “EDIT” button 338. In accordance with one or more embodiments, an alternative timing for the task can be provided to the user, such as by way of a suggestion provided by the system. For example, portion 320 provides a suggestion for changing one or both of the start and end dates and/or times, a reason for the suggested change and other related information, e.g. a related task. If another task is related in some way to the suggested modification, the user can be given the option, e.g., via link 330, to view details about the related information. The user can submit the changes made to the task information by selecting the “SUBMIT” button 322A. The “CANCEL” button 322B can be used to cancel the input entered by the user, e.g., since the last save operation. The user can perform a save operation by selecting the “SAVE” button 322C. Once the user submits the task, e.g., by using the “SUBMIT” button, the task is processed so that a determined community can evaluate and approve the task.

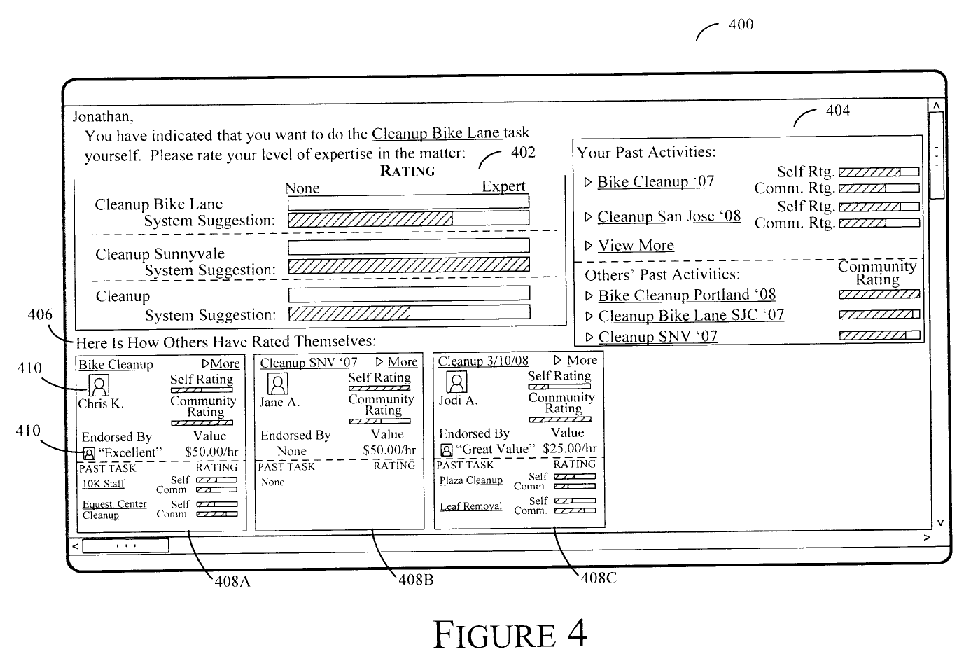

In accordance with one or more embodiments, a level of a user's expertise, e.g., in performance or valuation, in connection with a given task can be identified by the system, e.g., based on feedback received from the user or from other users, or generated by the system based on evaluation information associated with a user's performance and/or valuation of one or more tasks, which evaluation information can be provided by the user and/or one or more other users, and/or generated by the system. In a case that a user wishes to provide information regarding the user's, or another user's, expertise, in accordance with one or more embodiments, the user can be provided with information to assist the user in identifying the level of expertise with respect to a given task. FIG. 4 provides an example of an expertise rating user interface element for use in accordance with one or more embodiments of the present disclosure.

Web page 400 comprises a display area 402 for use by the user to enter an expertise rating in connection with one or more tasks that the user has indicated a desire to perform, a display area 404 that displays information about self and community ratings for past tasks performed by the user, and a display area 406 that displays information about how one or more other users have rated themselves and how the community has rated the one or more other users in connection with one or more current and/or past tasks.

More particularly, display area 402 includes a bar that can be adjusted to indicate a level of expertise, e.g., from “None” to indicate no expertise to “Expert” to indicate an expert level, for each task listed in display area 402. In addition, each task has a suggested level of expertise for the task that is provided by the system. The user can use the system suggestion of the user's level of expertise for a given task shown in display area 402 to aid the user in assessing the user's own level of expertise. Display area 404 can be used to display self and community ratings for tasks previously performed by the user. In addition, the display area 404 can display the community's ratings with respect to one or more tasks performed by other users. Display area 406 displays rating information corresponding to other users, e.g., self and community ratings information in connection with tasks performed by one or more other users. For example, each of areas 408A to 408C correspond to a user other than the user, e.g., “Jonathan”, currently providing input. With reference to area 408A, for example, a user's self and community ratings for a task entitled “Bike Cleanup” are provided. Additional ratings associated with other recent tasks performed by this user can be seen by selecting the “More” link. As shown in the example of FIG. 4, area 408 can include endorsements by other users, which can include a text portion and/or an appraised value, e.g., in monetary terms, of the user's task performance. A representative image e.g., an avatar, 410, and/or other information such as a user's name, nickname, etc., can be provided to assist user to identify the other user for which rating information is being provided. Areas 408 can identify recent tasks performed by the user as well as other tasks performed in the past. As can be seen in area 408A, self and community rating information can be provided for less recent task, in addition to the rating information provided for more recent tasks. The task titles can act as links, so that the user can view more details related to each task. For example, if the user selects a task title, all or a portion of web page 300 might be displayed for the user to view details of the task. In such a case, a “BACK” button can replace the “SUBMIT”, “CANCEL” and “SAVE” buttons 322A to 322C, respectively.

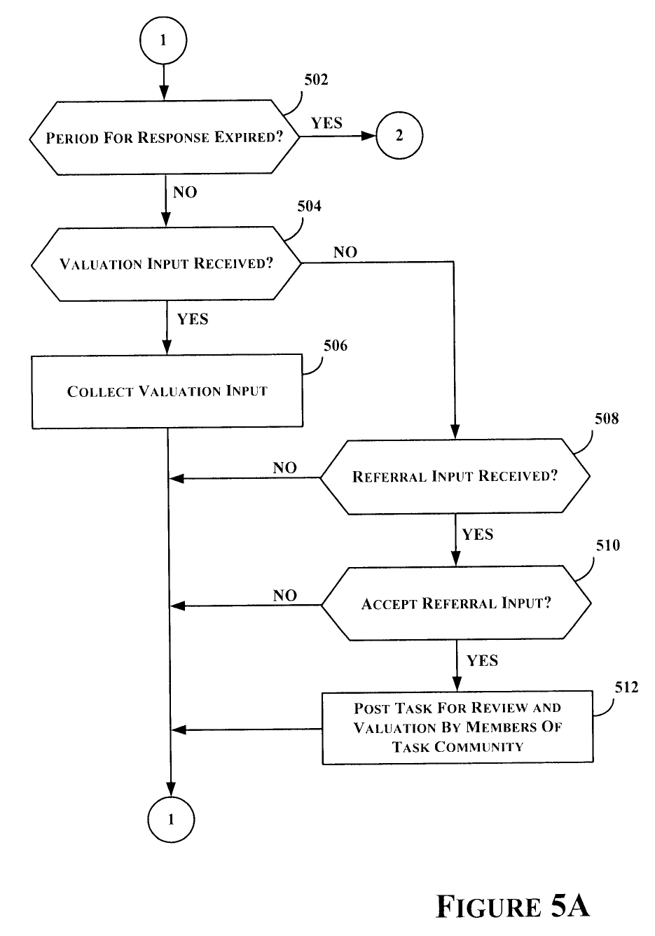

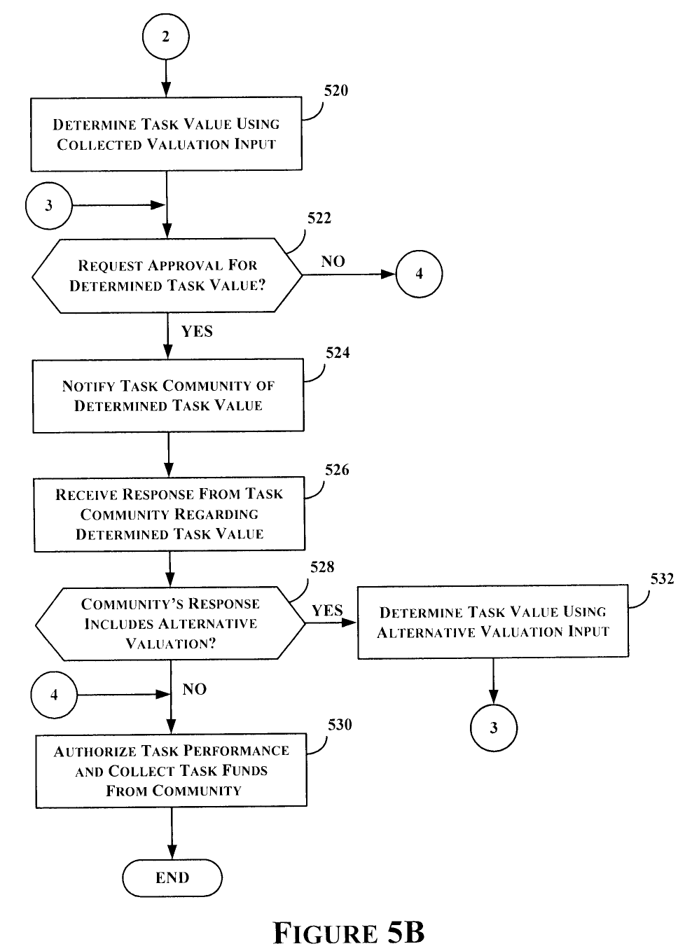

In accordance with one or more embodiments, after a user submits a task for valuation and approval, e.g., by selecting the “SUBMIT” button 322A of FIG. 3, a community of users is determined. The community of users is asked to provide value, or other input, for the task, and to approve the task for performance by the one or more performers identified for the task. Embodiments of the present disclosure use the valuation input received from the task community to determine a value for the task. FIG. 5, which comprises FIGS. 5A and 5B, provides an example of a task value determination process flow in accordance with one or more embodiments of the present disclosure.

Embodiments of the present disclosure solicit input from the community, which input includes task valuation input. In accordance with one or more such embodiments, members of the community are notified, e.g., using a communication mechanism such as RSS, a text message, electronic mail message, etc., that they are a part of a community that will fund a given task and that their input is requested to value the task. In general, in accordance with one or more embodiments, task valuation input received from a task's community is used to determine the value of the task. An initial value can be presented to the members of the community, for review, approval or modification. An initial task value can be an estimate based on the number of hours and an hourly rate, one or both of which can be based on input received from the task creator, based on historical information, and/or based on input from another person, e.g., a user with expertise in the area of endeavor of the task. An estimated task value can be, for example, the product of the hours identified to complete the task and an hourly rate associated with the task. For example, in a case that a typical hourly rate for a sweeper is ten dollars per hour and an approximate time to sweep the town square that is estimated to have a size of an acre is estimated to be five hours, an initial task value would be fifty dollars (e.g., $10.00*5 hrs.). The $50.00 estimate for the task of sweeping the town square can be presented to the community of users identified to value the task as an initial value of the task.

By way of a non-limiting example, an initial value can be provided by the user that entered/created the task, by another user, and/or determined from historic information, e.g., from values of one or more previously-valued tasks. Alternatively, the task can be presented to the member community without an initial value being provided. A task value, e.g., an initial value or a value received from a community member for the task, can be a single value, such as a monetary (e.g., dollar) amount, or a range of values, which comprises a first value and the second value that is greater than the first value. In a case of a value range, a value can be selected that falls within the value range, e.g., based on an extrapolation of the value ranges provided.

FIG. 5, which comprises FIGS. 5A and 5B, provides an example of a task valuation flow in accordance with one or more embodiments of the present disclosure. At step 502, a determination is made whether or not a period for response has expired. If not, processing continues at step 504 to determine a type of input received. It is determined at step 504 that the input received is valuation input, processing continues at step 506 to collect the valuation input, and processing then continues at step 502 to process any additional input received during the response period.

In accordance with one or more embodiments of the present disclosure, a community member can optionally identify one or more users that the community member considers to have knowledge regarding the value of the task, and the received input can therefore be a referral response. If it is determined at step 504, that the input received is not valuation input, processing continues at step 508 to determine whether the input received is referral input. If it is determined at step 508 that the input received is not referral input and is not valuation input, processing continues at step 502 to process any additional responses received during the period for response. It is determined at step 508 that the input received is referral input, processing continues at step 510 to determine whether or not to accept the referral input. If not, processing continues at step 502. If the referral is accepted, processing continues at step 512 to post the task for review and evaluation by the referred users. By way of a non-limiting example, a notification can be sent to the referred user to request the user to provide the requested input. Input received from a referred user can be collected together with the input received from the member community, and can be used to determine a value for the task. Processing continues at step 502.

In accordance with one or more embodiments, referred users can comprise previously identified members of the community and/or users other than previously identified members of the community. A weighting can be applied to valuation input received from a referred user to minimize or maximize the impact of a referred users valuation input in determining a value for the task. Generally, weightings can be used to maximize input received from any user, e.g., a user either within or outside the task's community that is considered to have some expertise concerning the task and/or valuation of the task.

If it is determined at step 502 that the period for response is expired, processing continues at step 520 of FIG. 5A to determine a task value using the collected valuation input. In accordance with one or more embodiments, a determine task value can be presented to the task community for approval. This step can be optional. A determination whether or not to seek community approval of the task value can be based on, for example, whether or not the valuation input received from the community varied among the community members. By way of a non-limiting example, community approval can be sought in a case that a variance measure determined using the valuation input received from the community members exceeds a variance threshold. To illustrate by way of a further non-limiting example, a task value can be determined to be an average of the task values received from the community. A standard deviation can be used as a measure of the degree to which the values received from the community are disperse, or divergent. A greater standard deviation suggests that there is less convergence among the values received than a lesser standard deviation. In accordance with one or more embodiments, a convergence threshold can be used to determine whether or not to seek approval of the determined task value from the member community.

In accordance with one or more embodiments, a task value range can be determined by selecting low-end and high-end values using the value input, and selecting a task value in the range, e.g., the mid range, the selected value being at least equal to the low-end value and no greater than the high-end value. The low-end value can be the least of the received values, and the high-end value can be the greatest of the received values. Other values can be selected for the low- and/or high-end values. By way of non-limiting examples, multiple ones of the low-end values received can be averaged and the average can be used as the low-end value, and/or multiple high-end values can be averaged with the average be used as the high-end value. By way of another non-limiting example, low- and high-end values can be determined based on valuation input received from users, e.g., within or outside the community, considered to have an expertise in connection with the task. By way of yet another non-limiting example and in a case that the community provides valuation input in the form of a value range, low- and/or high-end values from each of the ranges received can be used to determine low- and high-end averages, respectively, which can be used as the low- and high-end values of the determined task value range. One or more embodiments of the present disclosure can use a convergence threshold for one or both of the low- and high-end values, to determine whether or not to seek approval from the community of a task value.

If it is determined at step 522 that the task value is to be presented to the task community for approval, processing continues at step 524 to notify the task community of the determine task value. At step 526, input is received in response from the task community regarding the determined task value. In accordance with one or more embodiments, the task community can respond by accepting the determined task value, or by indicating a disapproval of the determined task value. In the latter case, an alternative task value can be input. At step 528, if a determination is made that the community's response includes alternative valuation input, processing continues at step 532 to determine an updated task value using the alternative valuation input. Processing continues at step 522 to determine whether or not to request approval for the updated task value. For example, one or more new convergence metrics can be generated and compared to a corresponding convergence threshold to determine whether or not to seek approval from the task community. A process of determining a task value based on the task valuation input received and soliciting approval of the determined task value can be performed any number of times until an acceptable convergence is achieved for the task value and/or the task value is approved by the task community. In accordance with one or more embodiments, approval of the task value by all of the members of the community can be required. Alternatively, approval by some percentage, e.g., at least 50%, can be used. As yet another alternative, approval by one or more of the members of the community can be weighted higher or lower than other members of the community. By way of a non-limiting example, community members that provide more of the funding for the task can be given a higher weighting than other members of the community.

At step 530, upon approval of the task value, performance of the task is authorized and funding for the task is collected from the community members.

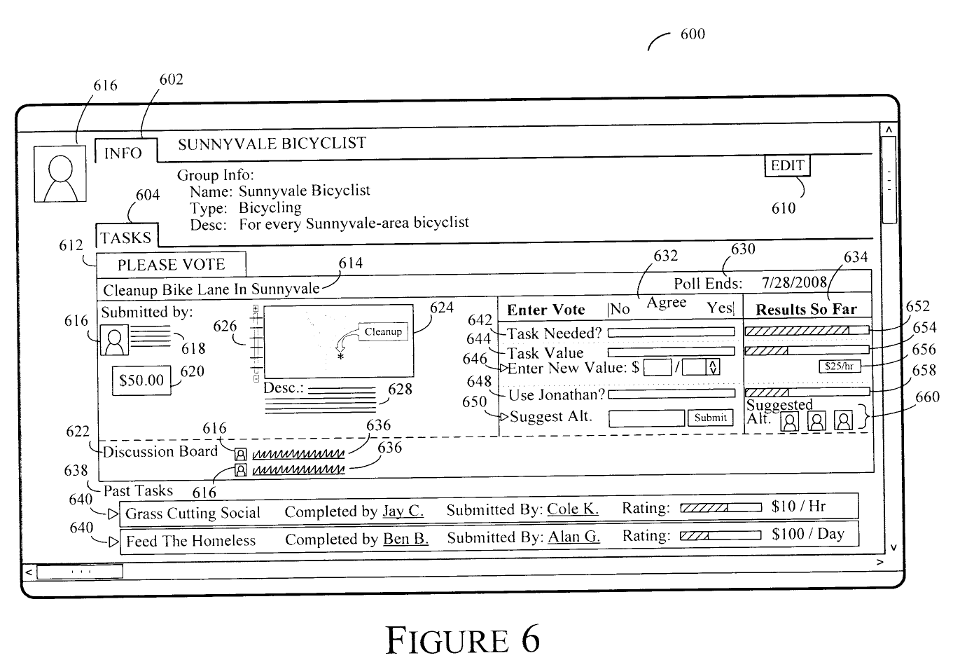

FIG. 6 provides an example of a task value entry user interface element for use by the community members to provide task input in accordance with one or more embodiments of the present disclosure. As with each of the user interface elements disclosed, the user interface element shown in FIG. 6 can be a web page delivered to a user's computing device by at least one server in communication with the computing device via a network, e.g., the internet. Web page 600 comprises a portion under “INFO” tab 602, which lists information about a group to which the user represented by avatar 616 belongs, and from which the task valuation input is solicited. By way of a non-limiting example, the group, or groups, identified under tab 602 can include the groups responsible for valuing and/or funding the task. Group information includes, without limitation, a group name, a group type and a group description. The user can edit the group information via “EDIT” button 610. Another portion of web page 600, under the “TASKS” tab 604, includes a voting section 612. In the voting section 612, the user can submit answers to one or more polling questions while the polling period remains open, the polling period being identified by the polling termination information 630. Field 614 includes task identification information, e.g., a name, or title, of the task. Field 614 can be a link that when selected provides additional information about the task. Avatar 616 provides a pictorial representation of the individual, or entity, that submitted the task, and field 618 lists other information associated with the individual or entity. Field 620 identifies pricing associated with the task that is to be reviewed by the task community. The information contained in field 620 can be a total price or a price per unit, e.g., amount per hour. A map 624 can be used to provide a pictographic representation of the location of the task. In the example shown in FIG. 6, map 624 includes a pointer, or call out, 664, which indicates a specific location of the task. Field 628 can include the description of the task. A zooming tool 626 provides an ability to zoom in and out in the map 624.

In area 632, the user can input answers to polling questions. By way of some non-limiting examples, the user can indicate, e.g., using a sliding scale, whether or not he/she agrees or disagrees that the task is needed. For example, the bar associated with inquiry 642 can include a lever that can be selected and moved from one side to the other to indicate total agreement (at the rightmost edge of the bar), total disagreement (at the leftmost edge of the bar), or some point in between. The user can use inquiry 644 and 646 to indicate the user's level of agreement with the value identified in field 620 for the task, and/or indicate a new value. By way of a further non-limiting example, the user can respond to inquiry 644 using a sliding scale to indicate the degree to which the user agrees with the current value. If the user wishes the user can enter a new value in the fields associated with inquiry 646, e.g., a monetary amount per hour, or other time interval or unit. The user can indicate whether or not he/she agrees with using the currently-identified person or entity, e.g., “Jonathan”, e.g., to perform the task using a sliding scale in answer to inquiry 648. The user can use inquiry 650 to suggest an alternative to the currently-identified person or entity to perform the task.

Area 634 can be used to display the results of the polling received from users thus far. For example, bar 652 can indicate an aggregate of the input received to inquiry 642. By way of a non-limiting example, the hashed area shown in bar 652 can indicate an average of the level of agreement determined from the input received from respondents. Bars 654, and in particular the hashed area in bar 654, represents the input received in response to inquiry 644. By way of a non-limiting example, the hashed area can identify an average of a degree to which the respondents agree with the current value of the task. Area 656 can be used to indicate a value determined from input provided by respondents via inquiry 646. By way of a non-limiting example, the value identified in area 656 can be a single value, e.g., an average of the input provided by the respondents, a range that indicates low and high values that have been provided by the respondents, or both. Bar 658 and the hashed area provided therein can be used to display the results of the input by respondents to inquiry 648, e.g., an average of the input provided by the respondents regarding each respondent's level of agreement to use the currently-identified one or more individuals and/or entities to perform the task. Area 660 identifies input provided by the respondents to inquiry 650, e.g. suggested alternative performer, or performers, for the task. In the example shown in FIG. 6, a pictorial representation can be used for a suggested performer.

In accordance with one or more embodiments, a discussion board 622 can be used to allow the respondents to make a point, or pose a question, in connection with the current task with other respondents, the system, and/or one or more past performers, for example. In the example shown in FIG. 6, an entry in the discussion board 622 identifies a message's author 616 and the content of the message 636. Area 638 of web page 600 can be used to list past tasks, to which a respondent can consult, for example, to obtain information useful in responding to the polling questions presented in connection with a given task. The past tasks listed in area 638 can be related in some manner with the task identified in area 612, but need not be. By way of a non-limiting example, a past task listed in an area 638 can be related to an identified performer of the task currently being valued, have a related description, etc.

In accordance with one or more embodiments, funds for a task can be collected from members of the community that provided input used to value the task. As is discussed above, funding can be obtained from other sources, such as a user or other party. By way of a non-limiting example, one party, e.g., a user, non-user or other entity, can donate an item of value to a second party in exchange for a commitment by the second party to perform a task, e.g., a task that has an assigned value based on input received from a community of users. In accordance with one or more embodiments discussed below, a mechanism can be used to ensure that there is an acceptable degree of separation between a user making a donation in connection with a task and the community providing input used to value the task. The assigned value of a task can be used as evidence of the amount of the charitable donation. In the example, the amount of the charitable donation, e.g., the value of the item donated, can correspond to the assigned value of the task. Other non-limiting examples of donations include other non-cash donations, e.g., donation of time spent the performance of a task, monetary donations, e.g., a monetary donation used to fund a task, etc. One or more embodiments of the present disclosure can provide information that can be used for tax purposes, and can provide an incentive for users to make a donation, e.g., to offer their time, in the connection with one or more tasks valued in accordance with one or more embodiments. In so doing, embodiments of the present disclosure can promote charitable acts. In accordance with one or more such embodiments, a statement can be generated to provide confirmation of the amount of the donation. If the donation is in the form of a monetary donation, the statement can identify the amount of money donated, for example. The statement can provide evidence of a noncash charitable donation. By way of a non-limiting example, the statement can provide confirmation of the amount of time spent on the task, together with evidence of the value of the time spent on the task, for example. If, as is discussed above, the donation comprises an item that is donated, the statement can provide evidence of the value of the task performed in return for the item being donated.

In accordance with one or more embodiments, in order to participate in the system, e.g., to identify a task, value a task, etc., users are authenticated and registered with the system. In order to verify information provided by the user during registration, a mechanism can be used that charges a user's credit card for a minimal amount, and requires the user to confirm an amount of money that has been charged to their credit card. This can be done to confirm that the user has provided a valid credit card, billing address, and name. For example, one or more charges can be made using the credit card and billing information provided by the user, e.g., two charges of 3 cents and 45 cents, and the user must confirm the amount of each charge. The charges are intended to verify the user's billing information, and the user's credit account can be credited for the amount of the charges. If the charges are made and successfully confirmed by the user, the user's identity is successfully authenticated, and a viable means of billing the user is identified.

In accordance with one or more embodiments, user authentication information can be assigned during registration, and can include a user name and password. The authentication information assigned for the user can be identified for the user by the system, or identified by the user and approved by the system, for example. The user name and password assigned for the user must then be used by the user each time the user wishes to gain access to functionality provided by the system. In accordance with one or more embodiments, the user name and password can be changed periodically based on system requirements, for example.

In accordance with one or more embodiments, as a prerequisite to a user's ability to use the functionality provided, a user can be required to agree to conspicuous express terms of service that are enforceable, so as to deter abuse. The terms of service can include a prohibition against users that enter a task and collaborate with users selected to value the task in an attempt to circumvent the system or fix prices, for example. Each user can be asked, as a prerequisite to completion of their registration, to agree that if the user is engaged in such practice, the user's ability to use the system can be revoked, either temporarily or permanently. As a deterrent, or in an effort to identify abusive use of the system, an “undercover agent” can pose as a user to test another user's trustworthiness and/or compliance with the terms of service, and system users can be informed that agents can/will be used. Use of such policing activity, or the threat of such use, can serve as a deterrent and/or actually find people who attempt to violate the terms of service by virtue of their interaction with an undercover agent. One example of a punishment that can be agreed upon by each user during the user's initial sign up process, is that any user caught abusing the system, e.g., by virtue of the user's interaction with an “undercover agent” or otherwise, can be identified to the other users of the system, e.g., by disclosing the user's full name and address to the other users on a bulletin board. In accordance with one or more embodiments, managers, and/or system administrators, etc., can be fully indemnified, so as to allow them to exercise their discretion to enforce the terms of service and prevent and/or eliminate abuse. In addition, the terms of service can require the user to agree to waive any claims of libel or slander.

In accordance with one or more embodiments, one or more persons that manage the system, i.e., managers, who may themselves be users, invite a person, as a trusted participant, to become a user. A person that is invited can invite some number of other persons that the invitee trusts, or is willing to personally vouch for. By way of a non-limiting example, a user can be allowed to invite twenty-five persons, and each invitee must agree to be governed by the terms of service.

In accordance with one or more embodiments, information can be collected to track a user's success with respect to inviting other users. If a user extends an invitation to an invitee and that invitee's user privileges are revoked, this information can be retained, and can negatively impact the inviter's reputation with respect to his ability to identify desirable users. An inviter's reputation might be indirectly negatively impacted. For example, if an invitee invites someone and that person's privileges are revoked, the reputation of the invitee is negatively impacted, and the reputation of the person that invited the invitee can be indirectly negatively impacted, albeit perhaps not to the extent of the impact on the invitee, since the invitee is the one that invited the person whose privileges were revoked.

In accordance one or more embodiments, information regarding inviter and invitee is maintained, such that for a given task, each member of the community that is to value a user's task must have some degree of separation from the user. For example, in a case that there must be at least three degrees, or levels, of separation and the invitation information indicated that user A invited user B, user B invited user C, user C invited user D and user D invited user E, user A could be a member of the community to value a task entered by user E, however users B, C and D could not. If user E is not “awarded” the task to perform until after the valuation input is received and used to determine the task's value, e.g., the value for the task is assigned before the task is assigned to user E to perform, the user base can be examined to determine whether a relationship between user E and any of the members of the user community that valued the task violate the separation rule. If so, the system can flag the case for review before final authorization is given to user E to perform the task.

In accordance with one or more embodiments, valuation information collected from a member of a user community that values a task can be reviewed to determine whether or not there are any anomalies that should be marked, e.g., as exceptions. For example, the member's valuation might diverge significantly from the valuation provided by other members of the community. In a case that a number of these exceptions are identified for a given user, an oversight committee, e.g., an editorial board, can be alerted so that a review of the user's actions can be performed, e.g., to determine whether or not the user's behavior is evidence of an intent on the user's part to game the system. In accordance with one or more embodiments, an editorial board can comprise some number, e.g., three, of editors that perform an independent review, and it can be a requirement that the editors unanimously agree that the user's actions is evidence of bad faith. In accordance with one or more embodiments, each editor evaluates the evidence independent of, and separate from, each of the other editors, and none of the editors are privy to the identity of the other editors or the editors' conclusions. In accordance with at least one such embodiment, after the all of the editors have rendered their independent vote/opinion that there is evidence of bad faith, a determination is made that the user has acted in bad faith. Consequences of such a finding of bad faith can include, without limitation, a temporary, or permanent, revocation of system use/privileges, a negative impact on the user's reputation, which can include a public rebuke, and/or a warning being given to the user that amounts to a notification of the board's findings. A user found to be in violation of the terms of service can be placed on probation for a period of time, in which if the user continues such action the user's privileges will be automatically and permanently revoked.

In accordance with one or more embodiments, a monetary penalty might be levied against a user found to be abuse the terms of service. By way of a non-limiting example, the terms of service agreed upon by the users can include an agreed upon monetary penalty, which can be automatically charged to the user's credit card. The terms of service can limit the degree to which imposition of such a penalty is reviewable.

In accordance with one or more embodiments, desirable behavior by a user can be reinforced. By way of a non-limiting example, occasions in which a user provides input to value a task that is approved and then performed to completion without any issues of abuse arising can be rewarded. Instances in which a user votes for tasks that result in completion without any abuse issues arising can serve to bolster or increase a user's reputation. User A that has a better reputation than user B can be given more preferential treatment than user B. For example, user A's valuation input could have greater influence than user B's valuation input in determining a task's value.

In accordance with one or more embodiments, a peer review can be used to give users an opportunity for review. For example, the relationship between a member of a user community that provided input used to value a task and the user that is awarded the task valued by the community can be revealed to the user community for review by the members of the community. Any user that is part of the user community can be given an opportunity to identify suspicious activity for editorial review.

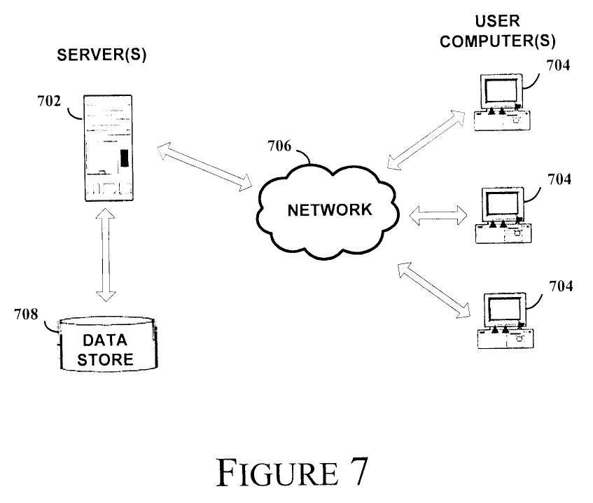

FIG. 7 illustrates components that can be used in connection with one or more embodiments of the present disclosure. In accordance with one or more embodiments of the present disclosure, one or more computing devices, e.g., one or more servers or other computing device, 702 are configured to provide functionality described herein. For example, a computing device 702 can be configured to provide web page definitions to one or more user computers, so that a user interface can be displayed at the user computer 704 for a user. Computing device 702, which can comprise one or more server computers, which are coupled to and maintain data store 708. In accordance with one or more embodiments of the present invention, data store 708 can store task information, user profile information, group information, input received from users, etc. that is to be used by the system in accordance with embodiments disclosed herein. In addition and in accordance with one or more embodiments, data store 708 can also include program code to configure a server 702 to perform methods in accordance with one or more embodiments of the present disclosure. Computing device 702 can serve web page content to user computers 704 using a browser application via a network 706.

The computing device 702 and the user computer 704 can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 702 and the user computer 704 can include one or more processors, memory, a removable media reader, network interface, display and interface, and one or more input devices, e.g., keyboard, keypad, mouse, etc. and input device interface, for example. One skilled in the art will recognize that server 702 and user computer 704 may be configured in many different ways and implemented using many different combinations of hardware, software, or firmware.

In accordance with one or more embodiments, a computing device 702 can make a user interface available to a user computer 704 via the network 706. The user interface made available to the user computer 704 can include one or more web pages including without limitation the web pages discussed herein. In accordance with one or more embodiments, computing device 702 makes a user interface available to a user computer 704 by communicating a definition of the user interface to the user computer 704 via the network 706. The user interface definition can be specified using any of a number of languages, including without limitation a markup language such as Hypertext Markup Language, scripts, applets and the like. The user interface definition can be processed by an application executing on the user computer 704, such as a browser application, to output the user interface on a display coupled, e.g. a display directly or indirectly connected, to the user computer 704.

In an embodiment the network 706 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 7. Alternatively, embodiments of the present disclosure can be implemented other environments, e.g., a peer-to-peer environment as one non-limiting example.

For the purposes of this disclosure a computer-readable medium stores computer data, which data can include computer program code executable by a computer, in machine readable form. By way of example, and not limitation, a computer-readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A computer-implemented method comprising:
receiving input identifying a task to be performed;
determining a community of users for the identified task from a user base;
requesting valuation input from the determined community of users; and
assigning a value to the task using the valuation input received from the determined community of users.

2. The method of claim 1, wherein the community of users that are requested to provide valuation input for the task are responsible for funding the task.

3. The method of claim 1, the step of determining a community of users for the identified task further comprising:
filtering the user base using one or more filtering criteria to identify the users from the user base that satisfy the filtering criteria.

4. The method of claim 3, the step of filtering further comprising:
filtering the user base by comparing geographic location information identified for the task with spatial information stored for one or more users in the user base; and
identifying the one or more users from the user base that have a spatial relationship with the identified task for inclusion in the community of users.

5. The method of claim 4, the geographic information associated with a user is provided by the user.

6. She method of claim 3, the step of filtering further comprising:
filtering the user base by comparing information identified for the task with information collected for the one or more users in the user base, the information for each of user being collected from input provided by the user or from monitoring the user's online activities; and
identifying the one or more users from the user base that have a relationship with the identified task for inclusion in the community of users.

7. The method of claim 1, further comprising:
collecting information about a user during a user registration.

8. The method of claim 1, further comprising:
monitoring a user's online activities; and
collecting information about the user based on the user's online activities.

9. The method of claim 1, the step of assigning a value to the task using the valuation input received from the determined community further comprising:
determining a monetary value of the task using the valuation input received from the determined community;
determining a convergence measure from the valuation input received from the determined community; and
comparing the determined convergence measure with a predetermined convergence threshold to determine whether or not to request approval from the determined community of the determined monetary value of the task.

10. The method of claim 9, further comprising:
requesting approval of the determined monetary value of the task in a case that it is determined that the convergence measure exceeds the predetermined convergence threshold.

11. The method of claim 9, the step of determining a monetary value of the task further comprising:
determining a value range comprising a low-end value and a high-end value; and
determining the monetary value of the task using the determined value range.

12. The method of claim 11, the step of determining the monetary value of the task using the determined value range further comprising:
determining a monetary value of the task that is at least equal to the low-end value and is no more than the high-end value.

13. The method of claim 11, the step of determining the monetary value of the task using the determined value range further comprising:
determining a monetary value of the task that is mid-range between the low-end value and the high-end value.

14. The method of claim 1, the step of assigning a value to the task using the valuation input received from the determined community further comprising:
determining a monetary value of the task using historical valuation input received in connection with one or more other tasks;

15. The method of claim 14, wherein the historical valuation input is received from the determined community in connection with one or more other tasks related to the task.

16. The method of claim 14, wherein the historical valuation input is received from one or more communities other than the determined community.

17. The method of claim 14, wherein the historical valuation input corresponds to one or more tasks that are similar to the task.

18. The method of claim 14, wherein the historical valuation input corresponds to one or more tasks associated with one or more members of the determined community.

19. The method of claim 1, the step of determining a community of users further comprising:
determining whether a relationship exists between a user that provided the task to be performed and another user determined for the user community; and
excluding the other user from the user community in a case that a relationship exists between the user that provided the task and the other user.

20. The method of claim 1, further comprising:
registering each user of the user base, so that information is received for each user during the user's registration; and
validating the user's identification information.

21. The method of claim 20, the step of validating further comprising:
causing at least one credit card transaction to be performed using credit card information provided by the user during registration, each credit card transaction performed to validate the user being for a different amount;
confirming from a source other than the user that each credit card transaction completed successfully; and
receiving input from the user confirming the amount of each credit card transaction.

22. The method of claim 20, the step of registering a user further comprising:
receiving agreement by the user to abide by terms of service, the user's agreement being a prerequisite to successful completion of the user's registration.

23. The method of claim 22, wherein the terms of service indicate that a violation of any provision of the terms service can result in punishment being imposed on the user.

24. The method of claim 22, wherein the punishment comprises notifying the user base of the user's violation.

25. The method of claim 22, wherein the punishment comprises temporarily revoking the user's privileges.

26. The method of claim 22, wherein the punishment comprises permanently revoking the user's privileges.

27. The method of claim 22, further comprising:
notifying the user base that adherence to the terms of service can be monitored by one or more undercover agents.

28. The method of claim 27, wherein the one or more undercover agents are users selected from the user base.

29. The method of claim 27, wherein the one or more undercover agent are individuals posing as users in the user base.

30. The method of claim 27, wherein the one or more undercover agents are a combination of users selected from the user base and individuals posing as users in the user base.

31. The method of claim 22, further comprising:
appointing a board comprising more than one member, the board being responsible for passing judgment in connection with the terms of service.

32. A system comprising:
one or more servers configured to:
receive input identifying a task to be performed;
determine a community of users for the identified task from a user base;
request valuation input from the determined community of users; and
assign a value to the task using the valuation input received from the determined community of users.

33. The system of claim 32, wherein the community of users that are requested to provide valuation input for the task are responsible for funding the task.

34. The system of claim 32, the one or more servers configured to determine a community of users for the identified task being further configured to:
filter the user base using one or more filtering criteria to identify the users from the user base that satisfy the filtering criteria.

35. The system of claim 34, the one or more servers configured to filter being further configured to:
filter the user base by comparing geographic location information identified for the task with spatial information stored for one or more users in the user base; and
identify the one or more users from the user base that have a spatial relationship with the identified task for inclusion in the community of users.

36. The system of claim 35, the geographic information associated with a user is provided by the user.

37. The system of claim 34, the one or more servers configured to filter being further configured to:
filter the user base by comparing information identified for the task with information collected for the one or more users in the user base, the information for each of user being collected from input provided by the user or from monitoring the user's online activities; and
identify the one or more users from the user base that have a relationship with the identified task for inclusion in the community of users.

38. The system of claim 32, the one or more servers being further configured to:
collect information about a user during a user registration.

39. The system of claim 32, the one or more servers being further configured to:
monitor a user's online activities; and
collect information about the user based on the user's online activities.

40. The system of claim 32, the one or more servers configured to assign a value to the task using the valuation input received from the determined community being further configured to:
determine a monetary value of the task using the valuation input received from the determined community;
determine a convergence measure from the valuation input received from the determined community; and
compare the determined convergence measure with a predetermined convergence threshold to determine whether or not to request approval from the determined community of the determined monetary value of the task.

41. The system of claim 40, the one or more servers being further configured to:
request approval of the determined monetary value of the task in a case that it is determined that the convergence measure exceeds the predetermined convergence threshold.

42. The system of claim 40, the one or more servers configured to determine a monetary value of the task being further configured to:
determine a value range comprising a low-end value and a high-end value; and
determine the monetary value of the task using the determined value range.

43. The system of claim 42, the one or more servers configured to determine the monetary value of the task using the determined value range being further configured to:
determine a monetary value of the task that is at least equal to the low-end value and is no more than the high-end value.

44. The system of claim 42, the one or more servers configured to determine the monetary value of the task using the determined value range being further configured to:
determine a monetary value of the task that is mid-range between the low-end value and the high-end value.

45. The system of claim 32, the one or more servers configured to assign a value to the task using the valuation input received from the determined community being further configured to:
determine a monetary value of the task using historical valuation input received in connection with one or more other tasks;

46. The system of claim 45, wherein the historical valuation input is received from the determined community in connection with one or more other tasks related to the task.

47. The system of claim 45, wherein the historical valuation input is received from one or more communities other than the determined community.

48. The system of claim 45, wherein the historical valuation input corresponds to one or more tasks that are similar to the task.

49. The system of claim 45, wherein the historical valuation input corresponds to one or more tasks associated with one or more members of the determined community.

50. The system of claim 32, the one or more servers configured to determine a community of users being further configured to:
determine whether a relationship exists between a user that provided the task to be performed and another user determined for the user community; and
exclude the other user from the user community in a case that a relationship exists between the user that provided the task and the other user.

51. The system of claim 32, the one or more servers being further configured to:
register each user of the user base, so that information is received for each user during the user's registration; and
validate the user's identification information.

52. The system of claim 51, the one or more servers configured to validate being further configured to:
cause at least one credit card transaction to be performed using credit card information provided by the user during registration, each credit card transaction performed to validate the user being for a different amount;
confirm from a source other than the user that each credit card transaction completed successfully; and
receive input from the user confirming the amount of each credit card transaction.

53. The system of claim 51, the one or more servers configured to register a user being further configured to:
receive agreement by the user to abide by terms of service, the user's agreement being a prerequisite to successful completion of the user's registration.

54. The system of claim 53, wherein the terms of service indicate that a violation of any provision of the terms service can result in punishment being imposed on the user.

55. The system of claim 53, wherein the punishment comprises notifying the user base of the user's violation.

56. The system of claim 53, wherein the punishment comprises temporarily revoking the user's privileges.

57. The system of claim 53, wherein the punishment comprises permanently revoking the user's privileges.

58. The system of claim 53, the one or more servers being further configured to:
notify the user base that adherence to the terms of service can be monitored by one or more undercover agents.

59. The system of claim 58, wherein the one or more undercover agents are users selected from the user base.

60. The system of claim 58, wherein the one or more undercover agent are individuals posing as users in the user base.

61. The system of claim 58, wherein the one or more undercover agents are a combination of users selected from the user base and individuals posing as users in the user base.

62. The system of claim 53, the one or more servers being further configured to:
appoint a board comprising more than one member, the board being responsible for passing judgment in connection with the terms of service.

63. A computer-readable medium tangibly embodying program code, the program code comprising code to:
receive input identifying a task to be performed;
determine a community of users for the identified task from a user base;
request valuation input from the determined community of users; and
assign a value to the task using the valuation input received from the determined community of users.

64. The computer-readable medium of claim 63, wherein the community of users that are requested to provide valuation input for the task are responsible for funding the task.

65. The computer-readable medium of claim 63, the code to determine a community of users for the identified task further comprising code to:
filter the user base using one or more filtering criteria to identify the users from the user base that satisfy the filtering criteria.

66. The computer-readable medium of claim 65, the code to filter further comprising code to:
filter the user base by comparing geographic location information identified for the task with spatial information stored for one or more users in the user base; and
identify the one or more users from the user base that have a spatial relationship with the identified task for inclusion in the community of users.

67. The computer-readable medium of claim 66, the geographic information associated with a user is provided by the user.

68. The computer-readable medium of claim 65, the code to filter further comprising code to:
filter the user base by comparing information identified for the task with information collected for the one or more users in the user base, the information for each of user being collected from input provided by the user or from monitoring the user's online activities; and
identify the one or more users from the user base that have a relationship with the identified task for inclusion in the community of users.

69. The computer-readable medium of claim 63, the program code further comprising code to:
collect information about a user during a user registration.

70. The computer-readable medium of claim 63, the program code further comprising code to:
monitor a user's online activities; and
collect information about the user based on the user's online activities.

71. The computer-readable medium of claim 63, the code to assign a value to the task using the valuation input received from the determined community further comprising code to:
determine a monetary value of the task using the valuation input received from the determined community;
determine a convergence measure from the valuation input received from the determined community; and
compare the determined convergence measure with a predetermined convergence threshold to determine whether or not to request approval from the determined community of the determined monetary value of the task.

72. The computer-readable medium of claim 71, the program code further comprising code to:
request approval of the determined monetary value of the task in a case that it is determined that the convergence measure exceeds the predetermined convergence threshold.

73. The computer-readable medium of claim 71, the code to determine a monetary value of the task further comprising code to:
determine a value range comprising a low-end value and a high-end value; and
determine the monetary value of the task using the determined value range.

74. The computer-readable medium of claim 73, the code to determine the monetary value of the task using the determined value range further comprising code to:
determine a monetary value of the task that is at least equal to the low-end value and is no more than the high-end value.

75. The computer-readable medium of claim 73, the code to determine the monetary value of the task using the determined value range further comprising code to:
determine a monetary value of the task that is mid-range between the low-end value and the high-end value.

76. The computer-readable medium of claim 63, the code to assign a value to the task using the valuation input received from the determined community further comprising code to:
determine a monetary value of the task using historical valuation input received in connection with one or more other tasks;

77. The computer-readable medium of claim 76 wherein the historical valuation input is received from the determined community in connection with one or more other tasks related to the task.

78. The computer-readable medium of claim 76, wherein the historical valuation input is received from one or more communities other than the determined community.

79. The computer-readable medium of claim 76, wherein the historical valuation input corresponds to one or more tasks that are similar to the task.

80. The computer-readable medium of claim 76, wherein the historical valuation input corresponds to one or more tasks associated with one or more members of the determined community.

81. The computer-readable medium of claim 63, the code to determine a community of users further comprising code to:
determine whether a relationship exists between a user that provided the task to be performed and another user determined for the user community; and
exclude the other user from the user community in a case that a relationship exists between the user that provided the task and the other user.

82. The computer-readable medium of claim 63, the program code further comprising code to:
register each user of the user base, so that information is received for each user during the user's registration; and
validate the user's identification information.

83. The computer-readable medium of claim 82, the code to validate further comprising code to:
cause at least one credit card transaction to be performed using credit card information provided by the user during registration, each credit card transaction performed to validate the user being for a different amount;
confirm from a source other than the user that each credit card transaction completed successfully; and
receive input from the user confirming the amount of each credit card transaction.

84. The computer-readable medium of claim 82, the code to register a user further comprising code to:
receive agreement by the user to abide by terms of service, the user's agreement being a prerequisite to successful completion of the user's registration.

85. The computer-readable medium of claim 84, wherein the terms of service indicate that a violation of any provision of the terms service can result in punishment being imposed on the user.

86. The computer-readable medium of claim 84, wherein the punishment comprises notifying the user base of the user's violation.

87. The computer-readable medium of claim 84, wherein the punishment comprises temporarily revoking the user's privileges.

88. The computer-readable medium of claim 84, wherein the punishment comprises permanently revoking the user's privileges.

89. The computer-readable medium of claim 84, the program code further comprising code to:
notify the user base that adherence to the terms of service can be monitored by one or more undercover agents.

90. The computer-readable medium of claim 89, wherein the one or more undercover agents are users selected from the user base.

91. The computer-readable medium of claim 89, wherein the one or more undercover agent are individuals posing as users in the user base.

92. The computer-readable medium of claim 89, wherein the one or more undercover agents are a combination of users selected from the user base and individuals posing as users in the user base.

93. The computer-readable medium of claim 84, the program code further comprising code to:
appoint a board comprising more than one member, the board being responsible for passing judgment in connection with the terms of service.
